(19) United States
(12) Patent Application Publication
(10) Pub. No.: US 2014/0132833 A1
(43) Pub. Date: May 15, 2014

(54) Combining Multiple Screens from Multiple Devices in Video Playback

(71) Applicants: Zhibing Wang, Beijing (CN); Deliang Fu, Beijing (CN); Xao Xiong, Beijing (CN); Heng Su, Beijing (CN); Joyce Zhang, Beijing (CN)

(72) Inventors: Zhibing Wang, Beijing (CN); Deliang Fu, Beijing (CN); Xao Xiong, Beijing (CN); Heng Su, Beijing (CN); Joyce Zhang, Beijing (CN)

(73) Assignee: Hulu, LLC, Los Angeles, CA (US)

(21) Appl. No.: 13/822,962

(22) PCT Filed: Nov. 12, 2012
(86) PCT No.: PCT/CN2012/084471

§ 371 Date: Mar. 13, 2013

(51) Int. Cl. H04N 9/12; H04N 5/268

(52) U.S. Cl. CPC H04N 9/12; H04N 5/268
USPC 348/383

(57) ABSTRACT

In one embodiment, a method determines multiple screens of multiple mobile computing devices should be combined in playback of a video. A first mobile computing device receives the video and determines device characteristics based on a positioning of the first mobile computing device in relation to a second mobile computing device. Playback characteristics are determined based on the device characteristics. Then, the first mobile computing device renders a first portion of the video on a first screen based on the playback characteristics where a second portion of the video is rendered on a second screen of the second mobile computing device.

### CROSS-REFERENCES TO RELATED APPLICATIONS

This application claims priority to International Patent Application No. PCT/CN2012/084471 filed Nov. 12, 2012 entitled “Combining Multiple Screens from Multiple Devices in Video Playback,” which is incorporated by reference in its entirety.

### BACKGROUND

More frequently, users are using mobile devices, such as smartphones, tablet devices, and laptops, to watch videos online as opposed to through television sets in the user's living room. In contrast to television sets, the mobile devices allow users to watch videos anywhere and anytime. Because of the mobility allowed, it becomes more likely that users may watch videos together. When the users are together, one of the users typically displays the video on his/her mobile device. This allows the users to watch the video together; however, the screen on the mobile device is typically a lot smaller than a television screen. Thus, although users are afforded additional mobility, the users must watch the video on a much smaller screen. This may make viewing by multiple users difficult, especially when the users are viewing the video on a smartphone. For example, a user who is not holding the smartphone may find it difficult to see the video.

### SUMMARY

In one embodiment, a method determines multiple screens of multiple mobile computing devices should be combined in playback of a video. A first mobile computing device receives the video and determines device characteristics based on a positioning of the first mobile computing device in relation to a second mobile computing device. Playback characteristics are determined based on the device characteristics. Then, the first mobile computing device renders a first portion of the video on a first screen based on the playback characteristics where a second portion of the video is rendered on a second screen of the second mobile computing device.

In one embodiment, a non-transitory computer-readable storage medium is provided containing instructions, that when executed, control a computer system to be configured for: determining multiple screens of multiple mobile computing devices should be combined in playback of a video; receiving the video at a first mobile computing device; determining device characteristics based on a positioning of the first mobile computing device in relation to a second mobile computing device; determining playback characteristics based on the device characteristics; and rendering a first portion of the video on a first screen of the first mobile computing device based on the playback characteristics, wherein a second portion of the video is rendered on a second screen of the second mobile computing device.

In one embodiment, an apparatus is provided comprising: one or more computer processors; and a non-transitory computer-readable storage medium comprising instructions, that when executed, control the one or more computer processors to be configured for: determining multiple screens of multiple mobile computing devices should be combined in playback of a video; receiving the video; determining device characteristics based on a positioning of the apparatus in relation to a mobile computing device; determining playback characteristics based on the device characteristics; and rendering a first portion of the video on a first screen based on the playback characteristics, wherein a second portion of the video is rendered on a second screen of the mobile computing device.

The following detailed description and accompanying drawings provide a better understanding of the nature and advantages of particular embodiments.

### BRIEF DESCRIPTION OF THE DRAWINGS

FIG. 1 shows multiple mobile devices that can be used to display media content according to one embodiment.

FIG. 2 depicts an example when mobile devices are moved together according to one embodiment.

FIG. 3 shows a second example of a layout using three mobile devices according to one embodiment.

FIG. 4 depicts a third layout using two mobile devices with different screen sizes according to one embodiment.

FIG. 5 shows a fourth example of a layout using three mobile devices of different sizes according to one embodiment.

FIG. 6 shows an example of a fifth layout using three mobile devices of different sizes according to one embodiment.

FIG. 7A depicts a first example of providing video to mobile devices according to one embodiment.

FIG. 7B depicts a second example of delivering video to mobile devices according to one embodiment.

FIG. 8 depicts a more detailed example for performing synchronization according to one embodiment.

FIG. 9 depicts a simplified flowchart of a method for combining mobile devices for display of a video according to one embodiment.

### DETAILED DESCRIPTION

Described herein are techniques for a system for combining multiple screens for viewing media content. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

### Overview

Particular embodiments provide a service that supports playback of media content, such as videos, web sites, pictures, and other content, using multiple mobile computing devices. For example, multiple users may put their mobile devices, such as smartphones, tablet devices, or laptops, together and view a video on a combination of the screens for the multiple devices. That is, the portions of the video are displayed on each mobile device form a single screen that is actually a combination of multiple screens.

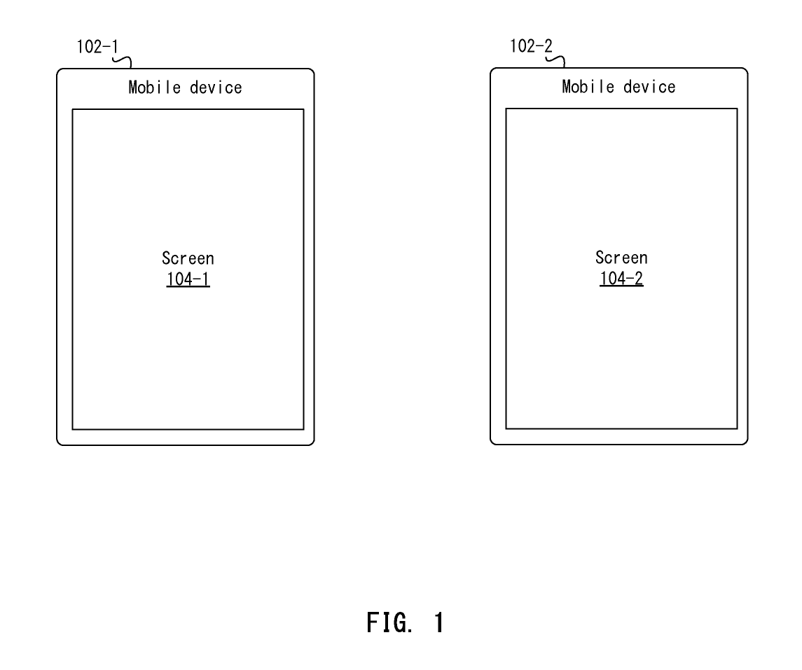

FIG. 1 shows multiple mobile devices 102 that can be used to display media content according to one embodiment. In FIG. 1, a first mobile device 102-1 and a second mobile device 102-2 that include a screen 104-1 and a screen 104-2, respectively. As discussed above, mobile devices 102 may be mobile in that users can move them to different positions. For example, users may position and move mobile devices 102-1 and 102-2 together in different positions and orientations. For example, screens 104-1 and 104-2 may be situated side by side to one another, such as screen 104-1 may be on the left side and screen 104-2 may be on the right side. Additionally, because mobile devices 102-1 and 102-2 are mobile, the sides can be switched (i.e., screen 104-1 may be placed on the right side and screen 104-2 may be placed on the left side). Users may also switch the screen orientation (e.g., portrait or landscape) and the number of mobile devices 102 used in the combination (e.g., more than two can be used).

### Layout Examples

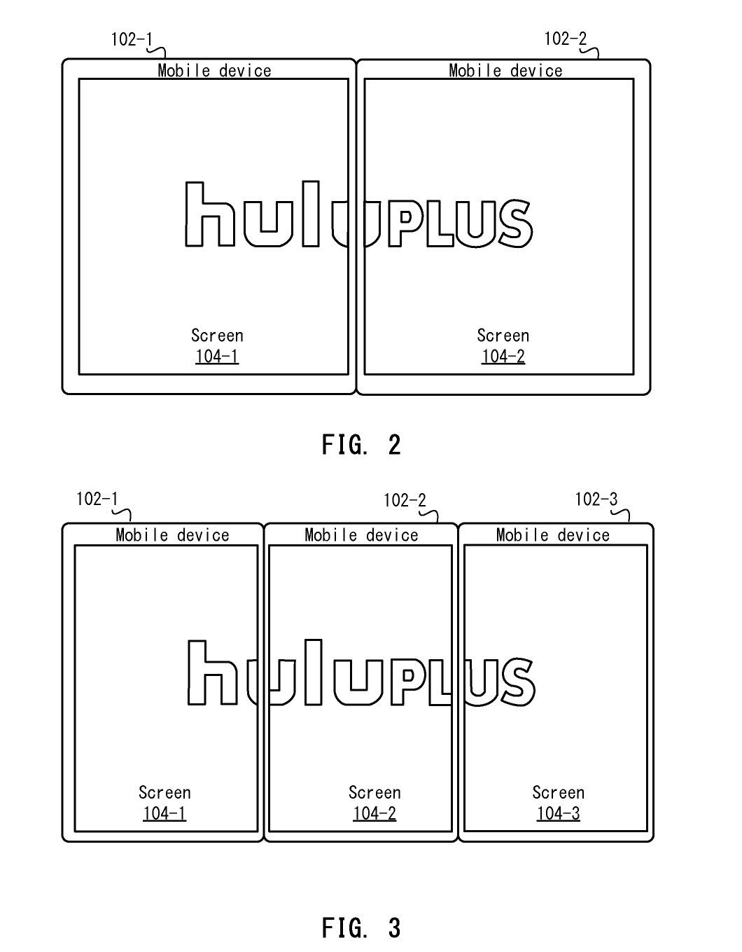

FIGS. 2-6 depict different layouts for different numbers of mobile devices 102. Particular embodiments may be described using video for discussion purposes; however, it will be recognized that the video may be any media content. FIG. 2 depicts an example when mobile devices 102-1 and 102-2 are moved together according to one embodiment. As shown, screen 104-1 and screen 104-2 form a single screen when viewed together. That is, screens 104-1 and 104-2 can display a single video together. Instead of screen 104-1 displaying the full video and screen 104-2 displaying the full video, screen 104-1 displays a first portion of the video (e.g., a left portion) and screen 104-2 displays a second portion (e.g., a right portion). When put together, the left portion and the right portion display a full version of the video. As shown, the video content has been split between the two screens 104. The video is denoted by “Hulu Plus” where a left portion of “Hulu Plus” is displayed on screen 104-1 and a right portion of “Hulu Plus” is displayed on screen 104-2.

Using the combination of screens 104-1 and 104-2 achieves a larger screen to display the video. Thus, even though mobile devices 102-1 and 102-2 may have screens 104-1 and 104-2 that are smaller than a typical television, combining screens 104-1 and 104-2 provides a larger screen than if only one mobile device 102 is used.

The screen size and number of mobile devices that are used may vary. For example, FIG. 3 shows a second example of a layout using three mobile devices 102-1, 102-2, and 102-3 according to one embodiment. In this example, three mobile devices 102-1, 102-2, and 102-3 are combined. In this case, the video is displayed on three different screens 104-1, 104-2, and 104-3. Also, in this example, the screen sizes are the same. Thus, the video may be split into thirds where screen 104-1 displays a left third, screen 104-2 displays a middle third, and screen 104-3 displays a right third.

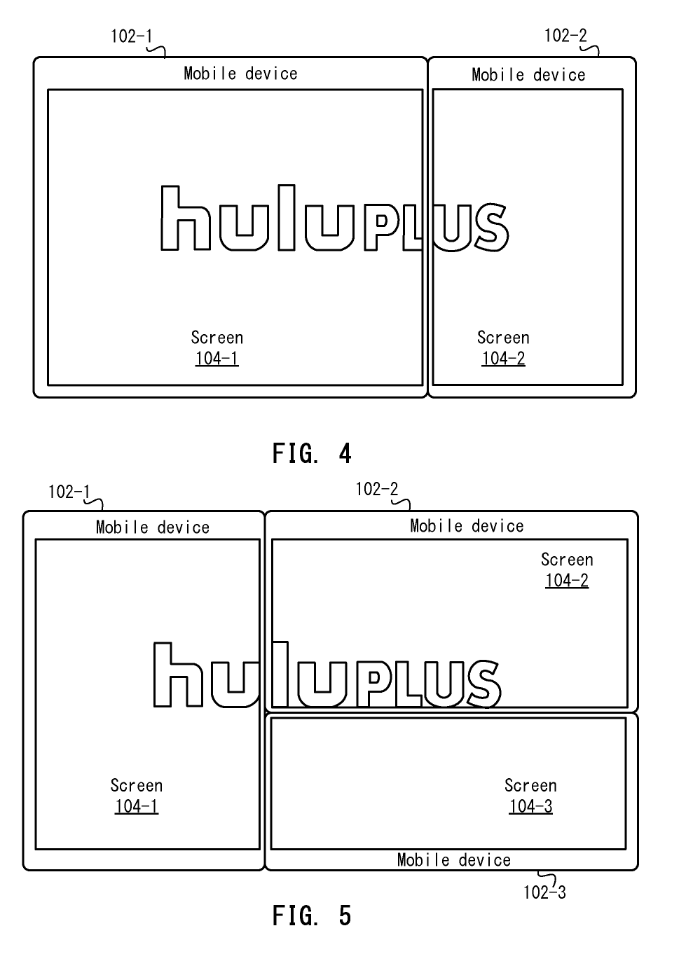

FIG. 4 depicts a third layout using two mobile devices 102 with different screen sizes according to one embodiment. In this example, a computing device 102-1 has a screen 104-1 that is larger than a screen 104-2 of mobile device 102-2. In this case, the portioning of the video may be different for each mobile device 102-1 and mobile device 102-2. For example, screen 104-1 of computing device 102-1 may display a left two thirds of the video while screen 104-2 may display a right one third of the video.

FIG. 5 shows a fourth example of a layout using three mobile devices 102-1-102-3 of different sizes according to one embodiment. As shown, mobile devices 102-1-102-3 include screens 104-1-104-3, respectively, that are of different screen sizes. Thus, screens 104-1-104-3 display different sized portions of the video. Also, mobile devices 102-2 and 102-3 may be in a different orientation than mobile device 102-1. That is, the screen direction is different. For example, screen 104-1 is in a portrait (i.e., vertical) orientation and screens 104-2 and 104-3 are in a landscape orientation (i.e., horizontal or wide screen).

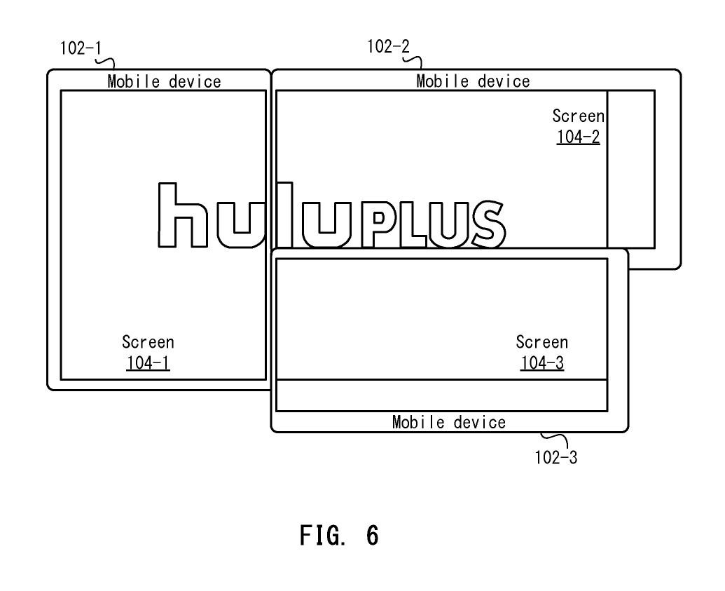

FIG. 6 shows an example of a fifth layout using three mobile devices 102-1-102-3 of different sizes according to one embodiment. In this layout, the full-sized video does not fully display on all screens 104-1-104-3 of mobile devices 102-1-102-3. For example, screens 104-2 and 104-3 may not fully display the video. This is because the screens when combined are not in a dimension to fully display video on the entire screen. Although the above layouts are described, other layouts may be appreciated.

### Video Delivery Examples

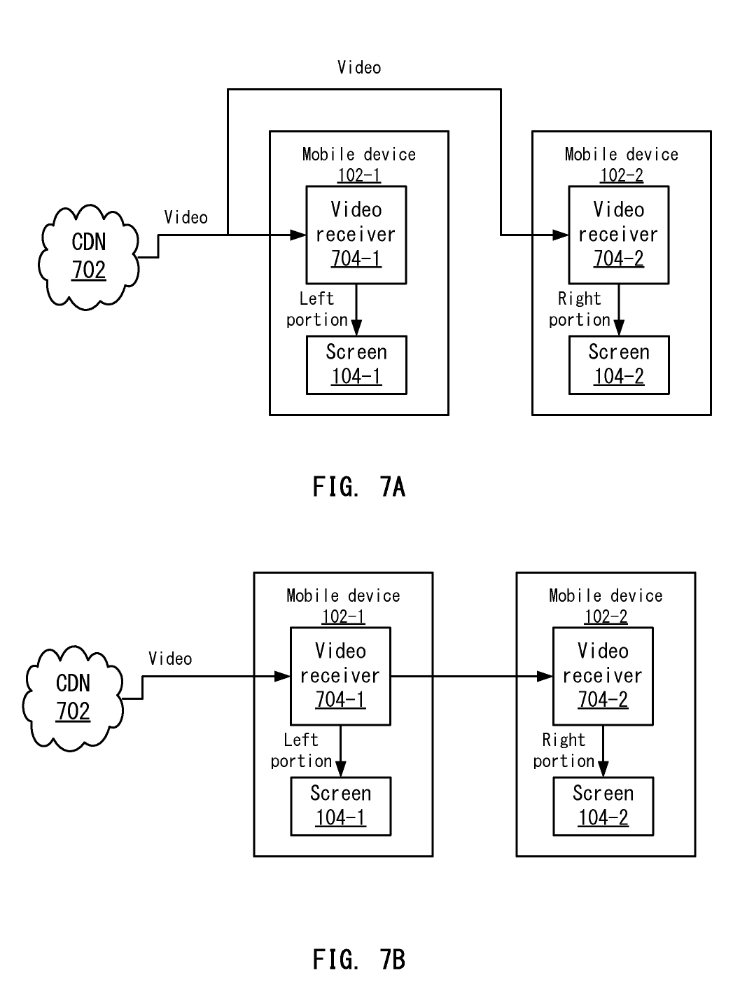

The video that is delivered to mobile devices 102 may be distributed differently. For example, a content delivery network (CDN) may deliver the video to both mobile devices or the CDN may deliver the video to a first mobile device, which then forwards the video to a second mobile device. FIG. 7A depicts a first example of providing video to mobile devices 102-1 and 102-2 according to one embodiment. Although two mobile devices 102-1 and 102-2 are shown, any number of mobile devices 102 may be used.

A CDN 702 includes a network of servers that deliver videos to mobile devices 102-1 and 102-2. As shown, a video receiver 704-1 for mobile device 102-1 and a video receiver 704-2 for mobile device 102-2 both receive the video. Video receivers 704-1 and 704-2 then render the video on screens 104-1 and 104-2, respectively. As will be described in more detail below, mobile devices 102-1 and 102-2 may synchronize to determine settings for displaying the video. For example, during the synchronization, video receivers 704-1 and 704-2 determine how to display the video on each screen 104-1 and 104-2, respectively. In one example, video receivers 704-1 and 704-2 determine the region and zoom that should be displayed on screens 104-1 and 104-2, respectively. As shown, screen 104-1 displays the left portion of the video and screen 104-2 displays the right portion of the video. Also, video receivers 704-1 and 704-2 may apply zoom to the video to properly display the left and right portions, respectively. This process will be described in more detail below.

FIG. 7B depicts a second example of delivering video to mobile devices 102 according to one embodiment. In this example, CDN 702 delivers video to a subset of mobile devices 102. For example, one mobile device 102 is a master device that receives the video and then sends the video to one or more slave devices. For example, video receiver 704-1 receives the video from CDN 702. In this case, video receiver 704-1 determines that the video needs to be forwarded to another mobile device 102-2. For example, during the synchronization, mobile devices 102-1 and 102-2 may determine that mobile device 102-1 should forward the video to mobile device 102-2. In this case, video receiver 704-1 forwards the video to video receiver 704-2.

### Synchronization

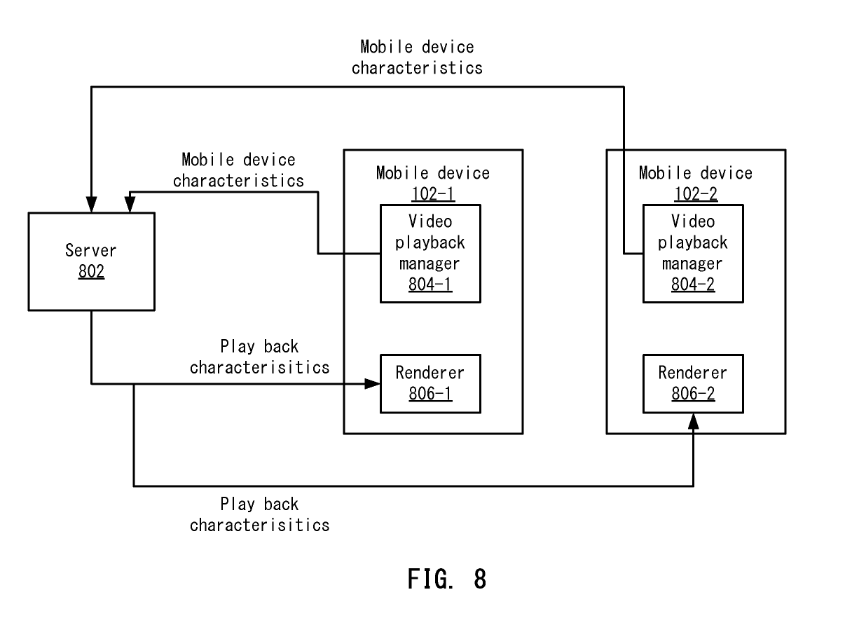

As discussed above, mobile devices 102 may perform synchronization to determine how to display the video. FIG. 8 depicts a more detailed example for performing synchronization according to one embodiment. To synchronize, a synchronization device should receive mobile device characteristics for each mobile device 102 that will be displaying the video according to one embodiment. The synchronization device can then analyze the mobile device characteristics and provide playback characteristics to each mobile device 102. The playback characteristics are used by each mobile device 102 to determine how to display the video, such as what region to display and what zoom should be applied to the video.

In this example, a server 802 is used to perform the synchronization. However, it will be understood that any device may perform the synchronization, such as even one of the mobile devices that are displaying the video. In one embodiment, a video playback manager 804-1 of mobile device 102-1 and the video playback manager 804-2 of a mobile device 102-2 send respective mobile device characteristics to server 802. The mobile device characteristics may include a display resolution, screen direction, screen size, and layout for the respective mobile device. The display resolution is the resolution in which each mobile device 102 will display the video. The screen direction is the orientation of screen 104 of each mobile device 102, such as portrait or landscape. The screen size is the size of screen 104 of each mobile device 102 including horizontal and vertical sizes. The layout may be a position of each mobile device 102 in the combination. For example, the layout may indicate that mobile device 102-1 is on the left side and mobile device 102-2 is on the right side.

Video playback managers 804-1 and 804-2 may automatically detect the resolution, screen size, and direction of screens 104-1 and 104-2, respectively. For example, video playback managers 804-1 and 804-2 may query settings of mobile devices 102-1 and 102-2 to determine the resolution and direction. For the layout, in one embodiment, mobile devices 102-1 and 102-2 may receive information for the layout from a user or users. For example, mobile devices 102-1 and 102-2 may output a query that allows the users to select which layout is being used and what position will be selected for each device. In one embodiment, a user may input on mobile device 102-1 that this mobile device is the left-hand-side mobile device and a user may input on mobile device 102-2 that this mobile device is the right-hand-side mobile device. In other embodiments, mobile devices 102-1 and/or 102-2 may output a selection of various layouts that may be possible. A user may then select one of these layouts.

In another embodiment, instead of users providing layout information, server 802 can also automatically decide the layout for each device based on display resolution and/or screen size. Once server 802 determines the layout characteristics, server 802 sends the layout information and screen direction together with other playback characteristics to mobile devices 102-1 and 102-2. A renderer 806-1 of mobile device 102-1 and a renderer 806-2 of mobile device 102-2 receive layout information and prompt users to combine their mobile devices according to the suggested layout and screen direction.

Once the display resolution, screen direction, and layout are determined, in the case where server 802 is performing the synchronization, video playback managers 804-1 and 804-2 send the mobile device characteristics to server 802. In the case where mobile device 102-1 is performing the synchronization, only mobile device 102-2 sends the mobile device characteristics to mobile device 102-1, which can then perform the synchronization.

Server 802 then analyzes the mobile device characteristics to determine playback characteristics. The playback characteristics define which region of the video should be displayed by each mobile device 102 and also if any zoom should be applied. For example, to display half of the video, mobile device 102 may double the zoom setting of the video and then display the left or right portion of the video. Depending on the number of mobile devices and screen sizes/orientations, the playback characteristics are different.

In one embodiment, particular embodiments may perform the following calculations to determine the region and zoom. In this process, particular embodiments may also use the screen size in addition to the resolution, screen direction, and layout when the pixel size of mobile devices 102 is different.

The process is summarized as:

1. Calculate the largest rectangular resolution (Res) that can be displayed on the combination of screens. The resolution may be calculated as follows:

Res=rec_size/pix_size_biggest,

where rec_size is a largest rectangular size of the combined screen (can be calculated from screen size, screen direction, and layout) and pix_size_biggest is the biggest pix_size of all the screens being used. The pix_size of each screen is calculated as follows:

pix_size=screen_size/screen_resolution,

where screen_size and screen_resolution are the size and resolution of the screen, respectively.

2. Calculate which part of the video should be displayed on each device using the screen size, screen direction, and layout.

3. Calculate the zoom of each mobile device 102 by using the screen resolution, resolution, and the part of the video that should be displayed on each mobile device 102.

In the above calculation, horizontal and vertical Res, rec_size, pix_size, pix_size_biggest are calculated separately. Here, note that the horizontal and vertical direction is defined by the layout of the screens, so the horizontal and vertical direction of a certain screen may change when the direction of the screen is changed.

Once server 802 determines the playback characteristics, server 802 sends the playback characteristics to mobile devices 102-1 and 102-2. A renderer 806-1 of mobile device 102-1 and a renderer 806-2 of mobile device 102-2 receive the playback characteristics for each respective mobile device. Renderers 806-1 and 806-2 analyze the playback characteristics and display the video on screens 104-1 and 104-2, respectively. For example, renderer 806-1 may select the left side of the video to display on screen 104-1 and renderer 806-2 may select the right side of the video to display on screen 104-2. In this case, renderer 806-1 may apply a zoom that enlarges the video by 2× and then displays the left side of the video. Renderer 806-2 may also enlarge the video by 2× and display the right side of the video. In this way, screens 104-1 and 104-2 display a full-size version of the video when users view both screens 104-1 and 104-2. There may be a synchronization signal sent to mobile devices 102 to enable playing/pausing the video of all mobile devices 102 at the same time. The synchronization signal can be part of the “play back characteristics”, or can be generated by one of mobile devices 102 and sent to other mobile devices 102.

Also, the synchronization information may indicate which mobile device 102-1 or 102-2 should play the audio for the video. For example, only one mobile device 102 may play the audio. In one example, if a master/slave relationship is used, the master mobile device 102 plays the audio. In other embodiments, both mobile devices 102 may play the audio.

### Method Flow

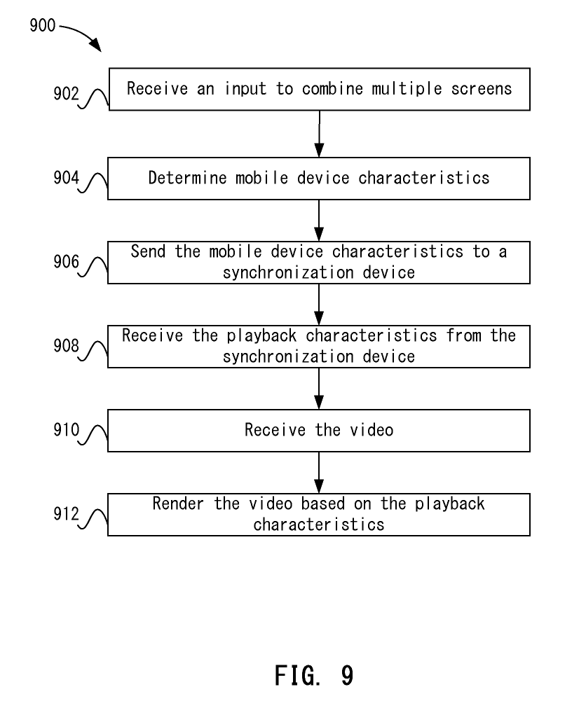

FIG. 9 depicts a simplified flowchart 900 of a method for combining mobile devices 102 for display of a video according to one embodiment. At 902, a mobile device 102 receives an input to combine multiple screens 104. For example, the input may indicate how many mobile devices 102 are participating in the combination. At 904, mobile device 102 determines mobile device characteristics. As discussed above, the display resolution and screen direction may be automatically detected, and the layout may be received from a user. At 906, mobile device 102 sends the mobile device characteristics to a synchronization device. As discussed above, the synchronization device may be a server 802 or a mobile device 102 that is participating in the video display.

At 908, mobile device 102 receives the playback characteristics from the synchronization device. Additionally, at 910, mobile device 102 receives the video. The video may be received from a CDN 702 or another mobile device 102. At 912, mobile device 102 renders the video based on the playback characteristics. For example, mobile device 102 may determine the region to display for the video and also apply any zoom that is necessary.

Accordingly, particular embodiments allow users to combine mobile devices 102 to display video together. By allowing users to combine screens 104 of mobile devices 102, a larger screen may be used to play the video.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
determining multiple screens of multiple mobile computing devices should be combined in playback of a video;
receiving the video at a first mobile computing device;
determining device characteristics based on a positioning of the first mobile computing device in relation to a second mobile computing device;
determining playback characteristics based on the device characteristics; and
rendering a first portion of the video on a first screen of the first mobile computing device based on the playback characteristics, wherein a second portion of the video is rendered on a second screen of the second mobile computing device.

2. The method of claim 1, wherein one or more additional portions of the video are rendered on one or more additional mobile computing devices.

3. The method of claim 1, wherein the first portion and the second portion display a full portion of the video on the first screen and the second screen.

4. The method of claim 3, wherein:
receiving the video comprises receiving the full portion of the video at the first mobile computing device, and
the first mobile computing device only displays the first portion.

5. The method of claim 1, wherein:
the device characteristics include a resolution of the first mobile computing device and the second mobile computing device, and
the playback characteristics indicate a region of the video and a zoom setting of the video based on the resolution.

6. The method of claim 1, wherein:
the device characteristics include a screen direction of the first mobile computing device and the second mobile computing device, and
the playback characteristics indicate a region of the video and a zoom setting of the video based on the screen direction.

7. The method of claim 1, wherein:
the device characteristics include a layout of the first mobile computing device and the second mobile computing device, and
the playback characteristics indicate a region of the video and a zoom setting of the video based on the layout.

8. The method of claim 1, wherein the playback characteristics are determined by a device other than the first mobile computing device or the second mobile computing device, or the first mobile computing device or the second mobile computing device determine the playback characteristics.

9. The method of claim 1, further comprising receiving information for the device characteristics from a user or detecting the device characteristics automatically.

10. The method of claim 1, wherein the video is received from the second mobile computing device.

11. The method of claim 1, wherein both the first mobile computing device and the second mobile computing device receive the video from a remote server.

12. The method of claim 1, wherein the positioning of the first mobile computing device and the second mobile computing device is changed such that the first mobile computing device outputs the second portion and the second mobile computing device outputs the first portion.

13. The method of claim 1, wherein only the first mobile computing device or the second mobile computing device outputs audio for the video.

14. A non-transitory computer-readable storage medium containing instructions, that when executed, control a computer system to be configured for:
determining multiple screens of multiple mobile computing devices should be combined in playback of a video;
receiving the video at a first mobile computing device;
determining device characteristics based on a positioning of the first mobile computing device in relation to a second mobile computing device;
determining playback characteristics based on the device characteristics; and
rendering a first portion of the video on a first screen of the first mobile computing device based on the playback characteristics, wherein a second portion of the video is rendered on a second screen of the second mobile computing device.

15. The non-transitory computer-readable storage medium of claim 14, wherein one or more additional portions of the video are rendered on one or more additional mobile computing devices.

16. The non-transitory computer-readable storage medium of claim 14, wherein the first portion and the second portion display a full portion of the video on the first screen and the second screen.

17. The non-transitory computer-readable storage medium of claim 14, wherein:
the device characteristics include a resolution, orientation, or layout of the first mobile computing device and the second mobile computing device, and
the playback characteristics indicate a region of the video and a zoom setting of the video based on the resolution.

18. The non-transitory computer-readable storage medium of claim 14, wherein the playback characteristics are determined by a device other than the first mobile computing device or the second mobile computing device, or the first mobile computing device or the second mobile computing device determine the playback characteristics.

19. The non-transitory computer-readable storage medium of claim 14, wherein the video is received from the second mobile computing device or both the first mobile computing device and the second mobile computing device receive the video from a remote server.

20. An apparatus comprising:
one or more computer processors; and
a non-transitory computer-readable storage medium comprising instructions, that when executed, control the one or more computer processors to be configured for:
determining multiple screens of multiple mobile computing devices should be combined in playback of a video;
receiving the video;
determining device characteristics based on a positioning of the apparatus in relation to a mobile computing device;
determining playback characteristics based on the device characteristics; and
rendering a first portion of the video on a first screen based on the playback characteristics, wherein a second portion of the video is rendered on a second screen of the mobile computing device.
